(19) United States
(12) Patent Application Publication
(10) Pub. No.: US 2002/0007316 A1
(43) Pub. Date: Jan. 17, 2002

(54) System for managing rechargeable vouchers of access to a service

(76) Inventor: Olivier Frank, Plats (FR)

Correspondence Address: Arthur L. Plevy, Esq., Duane, Morris & Heckscher LLP, Suite 100, 100 College Road West, Princeton, NJ, 08540, US

(21) Appl. No.: 09/839,744

(22) Filed: Apr. 20, 2001

(30) Foreign Application Priority Data
Apr. 27, 2000 (EP) 00410043.4

(51) Int. Cl. G06F 17/60

(52) U.S. Cl. 705/17

(57) ABSTRACT

The present invention relates to a system for managing rechargeable vouchers of access to a service, wherein the service payment operation is separate from the voucher recharging operation, this last operation being performed upon insertion of the voucher into a service access validation station.

### BACKGROUND OF THE INVENTION

1. Field of the Invention

For many services, vouchers, tickets or cards (these terms will be used indifferently hereafter) provided with memorizing means are now used, said vouchers being rechargeable after the service has been used a certain number of times or for a certain duration. For example, the access voucher may be a permit for access to premises reserved to selected persons or requiring a charge for admission, a transportation ticket, a payment card enabling access to a very large number of types of services or buying of products. A rechargeable ticket includes a memory that stores non-deletable and protected identification data and data corresponding to a limited or unlimited authorization of use.

2. Discussion of the Related Art

In the case where the voucher is a ticket of access to a transportation system, the user presents his ticket to a validator each time he gets on the transportation means or he wants to open an access barrier. The access is validated or not according to the ticket state. A sound device or other may inform an inspector of the fact that the ticket has expired or is not valid, or the ticket may be invalidated or swallowed by the validator.

Usually, when desiring to recharge such a rechargeable voucher, a user must come to a specific counter or to a vending machine to pay and recharge his voucher. A vending machine, shown in FIG. 1, includes a location 1 intended for receiving the rechargeable voucher and various locations of insertion of payment means, for example, slots 2 for coins, a slot 3 for banknotes, a slot 4 for a credit card, and a keyboard 5. To recharge his voucher, the user places it on location 1 and introduces money into slots 2 and/or 3, or introduces a credit card into slot 4 and dials a code on a keyboard 5, which enables him to perform a validation. The keyboard may enable selecting the parameters (type, amount, duration, . . . ) of the recharge that the user desires to perform, and may enable giving a bank transfer order. Various other automatic recharge systems are known.

Such systems of recharge of rechargeable vouchers has disadvantages, especially when the vouchers in question are transportation tickets with a monthly validity duration. Indeed, little before the end of a month, users must recharge their ticket and, for this purpose, they must go to a vending machine, a sales office, an agent, or other. In all cases, since all users tend to go substantially at the same period, waiting line phenomena, unpleasant for the user and difficult to manage for the operator, inevitably occur. This disadvantage is enhanced when the beginning of a month or other beginning of a validity period corresponds to the end of a vacation period, for example at the beginning of a new school term. To avoid being overburdened, the manager must make significant investments in terms of automatic ticket recharge machines and/or of number of agents or sales offices. The machines, intended for enabling management of peak periods, are little used during a very large portion of a month, which makes the corresponding investments particularly problematic.

### SUMMARY OF THE INVENTION

Thus, an object of the present invention is to provide a novel rechargeable voucher management system, especially enabling avoiding problems of waiting lines or of multiplication of distribution points.

Another object of the present invention is to provide a validator enabling a recharge of the card.

To achieve these objects, the present invention provides a system for managing rechargeable vouchers of access to a service, in which the service payment operation is separate from the voucher charging or recharging operation, this last operation being performed upon presentation of the voucher to a service access validation station.

According to an embodiment of the present invention, payment information corresponding to determined card numbers are stored at the level of a central station, which periodically transmits a portion at least of this information to at least some selected ones of the validation stations.

According to an embodiment of the present invention, upon payment, the voucher user provides an indication about the first validation station(s) to which he is likely to go.

According to an embodiment of the present invention, applicable to periodic recharge vouchers, at the end of each period, each voucher presented to a validator is automatically recharged, the voucher validity being then checked at the level of a central station by comparison between the list of recharged vouchers and a list of vouchers for which the recharge has been paid for, a list being then made of the vouchers for which the recharge has been performed and not paid for, this last list being periodically transmitted to some or to all validators, to enable them to totally or partially inhibit the vouchers belonging to this last list.

According to an embodiment of the present invention, for charging or recharging a voucher, the system automatically determines according to statistical criteria certain validation stations to which said voucher is likely to be presented.

The present invention also provides a validator of the access to a service by a rechargeable voucher, including means for reading the voucher number, recharging the voucher, and storing a list of vouchers, the validation of which is authorized and/or forbidden.

The foregoing objects, features and advantages of the present invention will be discussed in detail in the following non-limiting description of specific embodiments in connection with the accompanying drawings.

### BRIEF DESCRIPTION OF THE DRAWINGS

FIG. 1 schematically shows a conventional vending machine;

FIG. 2 illustrates the general diagram of a rechargeable voucher management system according to the present invention;

FIG. 3 schematically shows an example of a validator according to the present invention; and

FIG. 4 is a flowchart illustrating an example of use of the validator of FIG. 3.

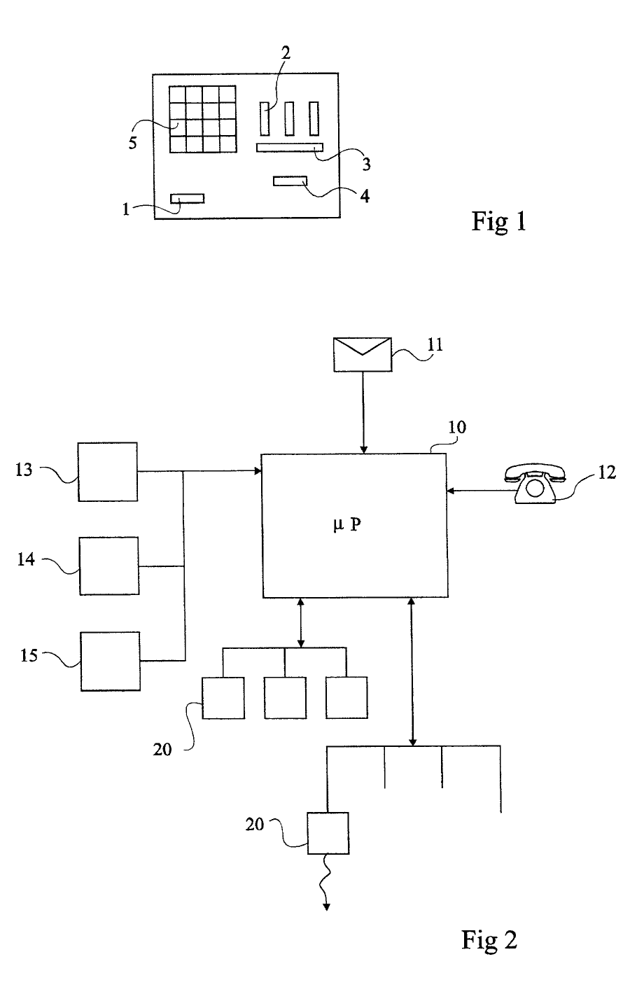

### DESCRIPTION OF THE PREFERRED EMBODIMENTS

According to a fundamental aspect of the present invention, the voucher recharge operation is decorrelated from the action of buying/selling this recharge.

The present invention provides a system of centralized management of payments 10, formed of a computer system, such as a microprocessor (μP) associated with a memory. The microprocessor manages several lists linked to the payment of the recharge of a voucher. The data may be input into the microprocessor by an operator upon reception of a mail 11, by an operator receiving telephone calls 12, or else directly by reception of a bank transfer information 13, by information of a payment by a credit card 14, by information from an automatic payment booth 15, by information from a private or public communication network. Thus, it is provided that the voucher user may give a recharge order by any payment means currently known or likely to be developed. In particular, this order may be given by a user from home or from his working place. This order is automatically or manually introduced in a list management system such as microprocessor 10. The microprocessor draws up a “white” list of all voucher numbers for which a recharge has been asked. The sole memorizing of these voucher numbers can suffice when the only provided possibility is that of an identical recharging. Other data will be contained in the white list when it will be provided that the new charging may be different from the preceding charging. The microprocessor may also store a “black” list, for example a list of numbers of tickets or cards which have been stolen, lost, or spotted as being fraudulent.

The recharge of the rechargeable voucher, that is, the writing into this voucher's memory of information relative to the possibility of using a given service for a given duration or a given number of times, occurs no longer at the level of specific machines, but at the level of validators 20 used upon each use of the rechargeable voucher. The validators are directly or indirectly coupled to central managing unit 10.

The recharge of a voucher by each validator may be performed in various ways. The entire white list may be communicated to all validators of a network, or list fractions may be communicated to all validators likely to be used by certain groups of users, or to specific validators for which the user has indicated upon buying that he would use them within a certain delay, for example one week, after the payment of the recharge.

Other schemes may be adopted to avoid overloading the memory of each of the validators if the “white” list is very long, which may occur in a network gathering a very large number of users. For example, in a bus network, the validators exchange data with microprocessor 10 via infrared or radio type links after or during daily inspection or fuel filling operations. This type of link has a limited capacity and it will be avoided to transfer too long lists amounting for example to more than 5,000 numbers, among which 500 black list numbers, and 4,500 validated numbers.

A network management mode will be indicated hereafter as an example only in the case of bus networks. The rechargeable vouchers are assumed to be prepaid transportation tickets of a monthly duration, which are identically recharged at the end of a month for the next month.

Central management system 10 memorizes as previously a “white”, list of all numbers of tickets for which the customers have paid for a recharge. The central system also memorizes a “black” list of the ticket numbers to be banned, for example stolen tickets, or tickets which have been spotted as being falsified. The central management system also memorizes a “red” list and a “blue” list, the functions of which will be discussed hereafter.

It will be provided in this system that, between a selected day in the month, for example, the 23^{rd}, and the last day in the month, any ticket presented in a bus will be automatically recharged by a validator of this bus and that the validator will establish a “grey” list of “seen” and recharged tickets. This grey list is communicated all evenings to the central system and this list is compared with the above-indicated “white” list. If a grey list number is not on the white list, it is placed on a “red” list indicating that this card has just been recharged, but that no payment has been performed for it. This red list is then transmitted to all validators likely to be concerned by the operation. When the validator receives a number present on its red list between the 23^{rd} and the end of the month, it just notifies the user that he has omitted to recharge his ticket. If, at the first day of the next month, the recharge has not been paid, the validator that sees a “red” list ticket inhibits this ticket by any known means and the user must then take a special step if he wishes to recharge it. Admitting that most users normally renew their vouchers, the number of red list tickets will be very small as compared to the number of white list tickets. Given that only the red list ticket numbers, possibly with the black list numbers, will have to be loaded in the validators, the necessary memory capacity and the list loading time are considerably reduced.

A “blue” list may also be provided at the level of the central management system, which corresponds to all white list numbers (paid recharge) for which, during the last days in the month, no corresponding ticket has been presented to a validator. At the end of the month, this blue list is communicated to the validators so that, if they receive a corresponding ticket, they recharge it normally.

Of course, various alternatives and modifications of this system may be devised and used by those skilled in the art, a fundamental aspect of the present invention being the decorrelation between the action of buying a service and the action of recharging a voucher of access to the service.

It may also be provided to only check transportation tickets by polling, for example, based on customer “regularity” information and by less inspecting the vouchers which appear to be regularly recharged than the vouchers having an irregular recharging.

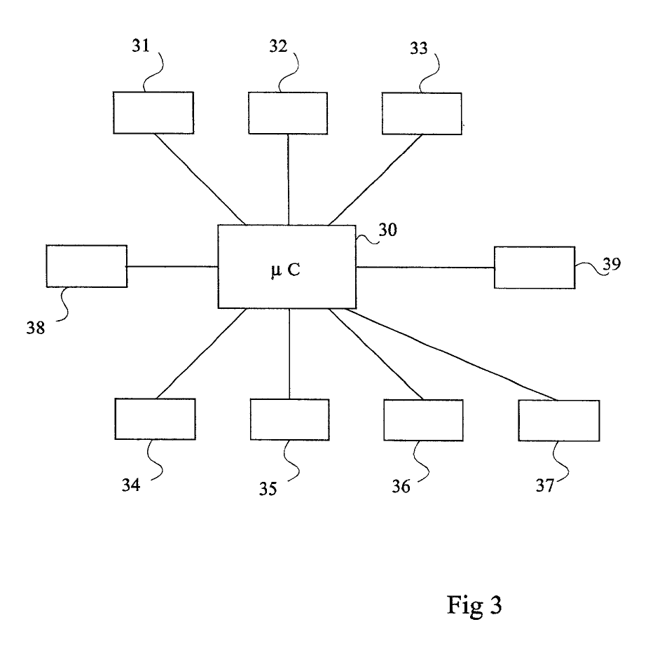

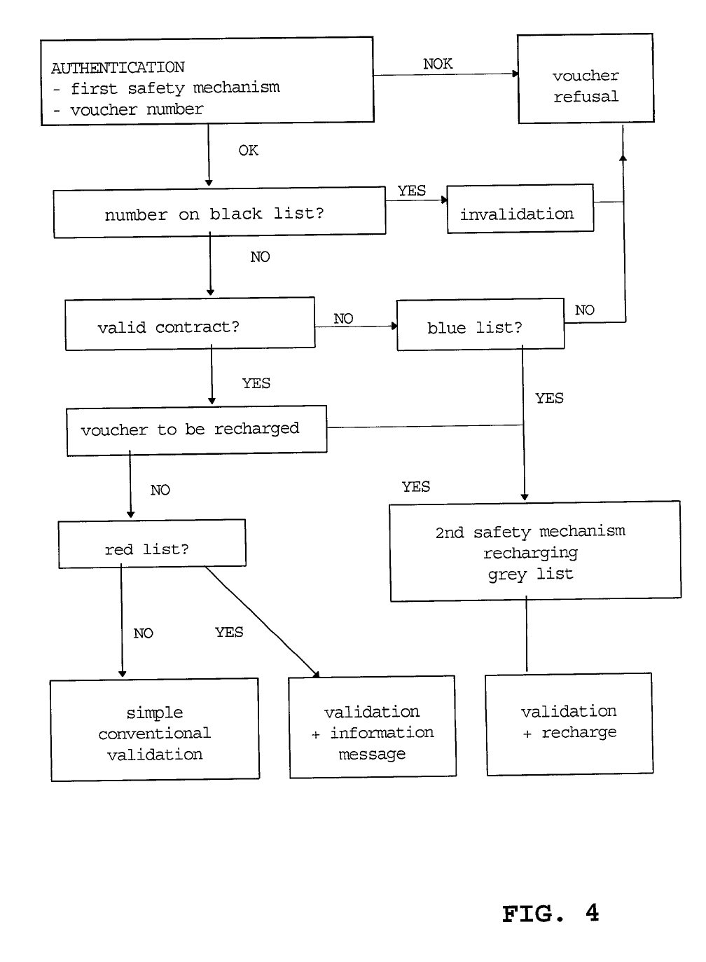

The present invention provides a validation device including not only the means for reading access units or access permits and for possibly debiting the voucher, but further including means for recharging the voucher. A validator 20 corresponding to the previously-described example is schematically shown in FIG. 3. A microcontroller 30 manages the validator operations. This validator is comprised of a first interface 31 for communicating with an embarked equipment, for example a GPS, a second infrared, GSM, or radio interface 32 for periodically communicating with management unit 10 and especially for transferring statistical data contained in a memory 38 to the management unit and receiving data, and a third interface 33 for communicating with a transportation ticket.

In the presence of a transportation ticket, the validator will follow the operations schematized in FIG. 4. The ticket will first be authenticated by a safety device based on secret keys contained in the validator memory, after which a confrontation of the ticket number will be made with the black list before starting the operations of search of the valid contract. This first phase is common to a validator according to the present invention and a validator of prior art. A first memory 34, which especially contains at least one secret key and the black list is used by the microcontroller 30 for these usual operations.

Then, a validator 20 for the described application of the present invention will enable performing the following additional operations:

if the ticket is not valid, its number will be confronted to the blue list contained in a memory 35; if the ticket is in the blue list, it will be considered as valid, and a process of identical recharge described hereafter will be started;

a memory 36 provides processor 30 with the rules for recharging the ticket; this memory especially contains the data enabling identification of a ticket requiring an identical recharge and possibly the white list;

if the ticket has been identified as a ticket to be recharged, a second safety mechanism similar to the first above-mentioned mechanism will unfold to make sure that validator 20 is allowed to write data on a ticket; then, the recharge data will be transmitted to the ticket by interface 33;

if the ticket is not to be recharged, there will however be a confrontation of its number with the red list contained in a memory 37; if the ticket is on the red list, the validation may come along with a message transmitted to the user via a display 39 to remind him that he must perform the payment corresponding to the already-performed identical recharge;

finally, in all recharge cases, the performed operation will be memorized in a grey list contained in memory 38 and intended for being transferred to central management system 10 via interface 32.

The identical recharge described in the above example is perfectly adapted to the context of prepaid subscriptions. One of the advantages of this system is to be able to guarantee the service prepayment. However, it is possible to grant more flexibility and to allow the voucher user to use it at the beginning of a new period after an identical recharge, before having received the payment; this will then be a semi-prepaid configuration.

Another advantage of the present invention is to enable to process the charging into a voucher of any service buying. In this case, the validators will perform this charging by identifying in the white list present in their memory 36 the numbers of the vouchers to be charged, and will, for example, transmit from this white list all the data characterizing the paid service to the voucher. The volume of the validator memory will be optimized by distributing only pieces of the white list into part of the existing validators according to the above-mentioned criteria.

1. A system for managing rechargeable vouchers of access to a service, wherein the service payment operation is separate from the voucher charging or recharging operation, this last operation being performed upon presentation of the voucher to a service access validation station (20).

2. The system of claim 1, wherein payment information corresponding to determined card numbers are stored at the level of a central station (10) which periodically transmits a portion at least of this information to at least some selected ones of the validation stations.

3. The system of claim 1, wherein upon payment, the voucher user provides an indication about the first validation station(s) to which he is likely to go.

4. The system of claim 1, applicable to periodic recharge vouchers, wherein, at the end of each period, each voucher presented to a validator is automatically recharged, the voucher validity being then checked at the level of a central station by comparison between the list of recharged vouchers and a list of vouchers for which the recharge has been paid for, a list being then made of the vouchers for which the recharge has been performed and not paid for, this last list being periodically transmitted to some or to all validators, to enable them to totally or partially inhibit the vouchers belonging to this last list.

5. The system of claim 1, wherein, for charging or recharging a voucher, the system automatically determines according to statistic criteria certain validation stations to which said voucher is likely to be presented.

6. A validator of the access to a service by a rechargeable voucher, including means for:
reading the voucher number,
recharging the voucher, and
storing a list of vouchers, the validation of which is authorized and/or forbidden.
